(19) United States
(12) Patent Application Publication
(10) Pub. No.: US 2002/0152150 A1
(43) Pub. Date: Oct. 17, 2002

(54) Visualization of asset information

(76) Inventors: Lisette Cooper, Weston, MA (US); Philip Cooper, Weston, MA (US); Benjamin Shectman, North Plainfield, NJ (US); Raymond LeClair, Acton, MA (US); Stewart Myers, Lexington, MA (US); Yongxiang Li, Branford, CT (US)

Correspondence Address: DAVID L. FEIGENBAUM, Fish & Richardson P.C., 225 Franklin Street, Boston, MA, 02110-2804, US

(21) Appl. No.: 09/836,484

(22) Filed: Apr. 17, 2001

(51) Int. Cl. G06F 17/60

(52) U.S. Cl. 705/36

(57) ABSTRACT

Visualization techniques enable information associated with assets to be easily visualized and understood.

### BACKGROUND

This application relates to U.S. patent application Ser. No. 09/641,589, filed Aug. 18, 2000, and incorporated by reference.

This invention relates to visualization of asset information.

Information about investment assets such as corporate securities is often presented as tables of values or ratios of values for successive time periods.

Sometimes graphs or visualization devices are used to provide a more intuitive view of the information.

One on-line service, Morningstar.com, uses a scatter plot in its Morningstar Investment Radar, URL (http://screen.momingstar.com/InvestmentRadar/InvestmentRadar. html). Each point in the plot represents risk versus capitalization of an asset in a portfolio.

Another on-line facility, FalconEye, URL (http://www.falconeye.com/falconeye/tracker/index.html), displays a periscope-like view of a simulated cloud formation that represents

a multi-dimensional density map of all 6000+ Nasdaq stocks, sorted in real-time by FalconEye Viz-Alerts™ (customizable indicators) that were created for the vertical and horizontal axes. Each stock is like a pixel on the screen and each color represents the density of stocks depicted in that section of the Tracker Live Map . . . The distribution of density allows you to instantly see the real-time technical pressures on the market and gives you the knowledge to trade more efficiently and productively.

ValuEngine, URL (http://valuengine.com/servlet/ValuationSummary#), displays graphs of stock prices that include historical prices to a current date followed by forecast price trends for future periods, including forecast ranges above and below the forecast price trends.

Among the kinds of information available at web sites on the Internet are current and historical prices and volumes of stock transactions, prices of put or call options at specific strike prices and expiration dates for various stocks, and theoretical prices of put and call options that are derived using formulas such as the Black-Scholes formula. Some web sites give predictions by individual experts of the future prices or price ranges of specific stocks.

A so-called “second-derivative method” for computing implied probability distributions of future prices from option price data is known in the academic literature, but apparently not very well known. For example, the standard textbook “Options, Futures, and Other Derivatives,” by John C. Hull (Fourth Edition, 1999; Prentice-Hall) mentions implied probabilities, but not the second-derivative method. Perhaps the best reference that we have been able to find is J. C. Jackwerth and M. Rubinstein, “Recovering probability distributions from option prices,” J. Finance, vol. 51, pp. 1611-1631 (1996), which has only six prior references. This paper cites D. T. Breeden and R. H. Litzenberger, “Prices of state-contingent claims implicit in option prices,” J. Business, vol. 51, pp. 631-650 (1978) as the originator of a second-derivative method, although the latter paper nowhere mentions probabilities.

### SUMMARY

In general, in one aspect, the invention features a method that includes (a) displaying to a user a circular visualization element having sectors arranged around a center of the element, the sectors respectively corresponding to different groups of assets, and (b) in each of the sectors, displaying an array of visual elements representative of respective assets belonging to the group to which the sector corresponds, the visual elements being arrayed with respect to distance from the center in accordance with magnitudes of performance of the assets during a recent period.

Implementations of the invention may include one or more of the following features. The visual elements comprise displayed dots, one for each of the assets. The visual elements exhibit visible characteristics that correspond to categories of the assets within the group. The categories of the assets within the group correspond to different capitalizations. The dots are arranged along a radius of the sector to which they belong. Dots that would otherwise lie on the radius at a given distance from the center are displayed at different angular positions near to the radius. Each sector has an angular extent that represents the fraction of asset items in the sector relative to the total number of asset items in the universe being plotted. The circular visualization element is subdivided into rings having respectively different distances from the center. The rings are displayed in different colors. The magnitudes of performance of the assets are measured in percentage price change. The recent period comprises a trading day on an asset market. The assets comprise securities issued by corporations.

In general, in one aspect, the invention features a method that includes displaying to a user a visualization element that indicates the odds of a performance measure of an asset being within specified ranges of identified values of the performance measure at a succession of times in the future.

Implementations of the invention may include one or more of the following features. The performance measure comprises a price of the asset or a return percentage or a tax-adjusted return percentage. The visualization element includes stripes superimposed on a graph of the performance measure over time, each of the stripes representing one of the specified ranges. Each of the stripes begins at a current time and becomes broader as it extends to future times. A graphical device shows actual historical values of the performance measure, e.g. in the form of a line graph one end of which joins the visualization element at a point that represents a current date. The visualization element includes two portions, one of the portions representing the odds prior to a specified date based on one assumption, the other of the portions representing the odds after the specified date based on another assumption. The specified date is a date on which tax effects change from the one assumption to the other assumption.

In general, in one aspect, the invention features a method that includes displaying to a user a visualization element having graphical indicators of the relative performance of a selected asset compared with the performance of groups of assets in each of a succession of time periods, each of the groups comprising assets representing a common style. The relative performance is determined using an asset class factor model.

The features of the invention enable a user to quickly visualize and grasp the significance of data that would otherwise be more difficult to understand.

Other advantages and features will become apparent from the following description and from the claims.

### DESCRIPTION

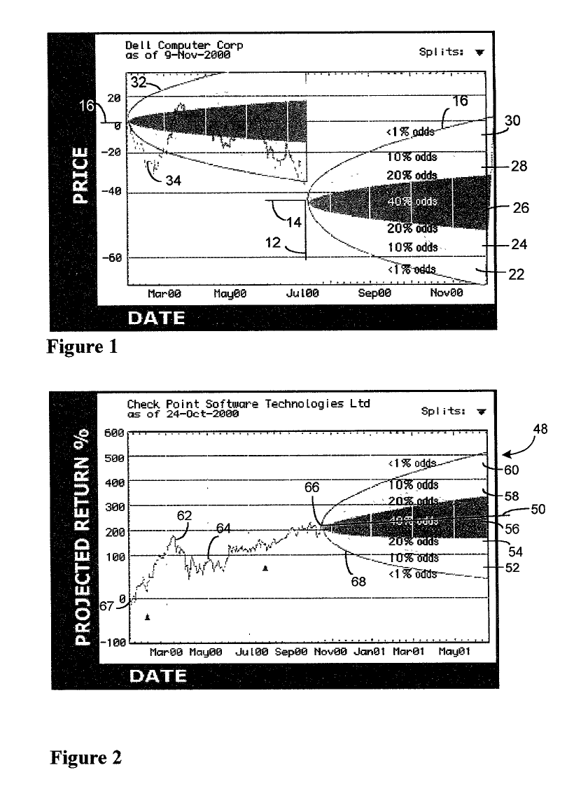

(FIGS. 1 through 5 show visualization techniques.)

The visualization techniques discussed below are useful in enabling users to visualize and quickly understand information that relates to assets.

Visualization of Implied Probability Distributions of Future Prices

As shown in FIG. 1, a visualization device 10 displays cumulative probability distribution values of predicted relative future prices of Dell Computer Corporation stock with respect to a current date 12 of Jul. 1, 2000. The price 14 on Jul. 1, 2000, is shown as being $41 lower than the price 16 on Feb. 1, 2000, which itself is set at an arbitrary starting value of $0 for purposes of display. The display could be provide in actual price terms, as a price change, or in terms of percentage return. The probability distribution data on which the visualization device 10 is based may be generated by, for example, the method discussed in the parent patent application.

The predicted cumulative distribution values of the prices of Dell stock over a period of several months into the future are illustrated by an envelope 16 that begins at a point 18 and opens to the right

The envelope 16 is divided into stripes 22, 24, 26, 28, 30, each of which also begins at point 18 and opens to the right. Stripe 22, for example, indicates a range of prices (all of which are below the current price) at each date in the future and indicates the predicted odds (10%) that the price will fall within that stripe. Similarly, stripe 26 indicates a range of prices (above and below the current price) with an expected 40% odds of occurring on various dates in the future. The odds of falling either above or below envelope 16 are, as indicated, less than 1%. Each stripe is displayed in a different color, and the colors are chosen to permit a viewer to visualize the different stripes easily.

A similar envelope 32 starts at the nominal $0 price on Feb. 1, 2000, and ends on the current date. Envelope 32 represents the cumulative distribution values of the prices of Dell stock that were predicted as of Feb. 1, 2001. The actual price history of Dell stock between Feb. 1, 2000, and the current date is illustrated by the line 34. The extent to which the actual price history of line 34 matches the predicted cumulative distribution values gives a visual indicator to the user of the validity of the prediction approach.

The combination of color, text, and data illustrated in FIG. 1 enable an investor to assess the performance of an asset over time relative to his price expectations.

The visualization device of FIG. 1 is also useful for assets other than stocks, including mutual funds, and for portfolios of assets.

FIG. 2 presents information similar to FIG. 1, but is expressed with respect to projected return percentage rather than price. The example shown in FIG. 2 relates to Check Point Software Technologies Ltd stock as of a current date 66 of Oct. 24, 2000. The x-axis represents return percentage with respect to a start date. Line 62 shows the historical return with respect to the stock price on the start date of Jan. 1, 2000 at point 67. On the current date 66, the cumulative return on the price of the stock since start point 67 is approximately 200%.

An envelope 68 starts at point 66 and opens to the right. The envelope 68 illustrates the projected odds of the percentage return being within certain ranges on each day for several months into the future relative to the original start point 66. The ranges are expressed as stripes 52, 54, 56, 58, and 60. The envelope and stripes are centered on a trend line 50 that has a slightly positive slope to reflect the probability of future price levels generated by a mathematical algorithm that is based on the implied volatility of the options market. The algorithm is described in the related pending U.S. patent application Ser. No. 09/641,589, filed Aug. 18, 2000.

For example, the projected odds that the return (relative to the start point 67) will be between 50 and 100% on May 1, 2000, is 10%.

The same kind of data used to generate the display of FIG. 1 is used to generate the device of FIG. 2 except that the data is processed to convert the price data into change of price data for plotting along the x-axis.

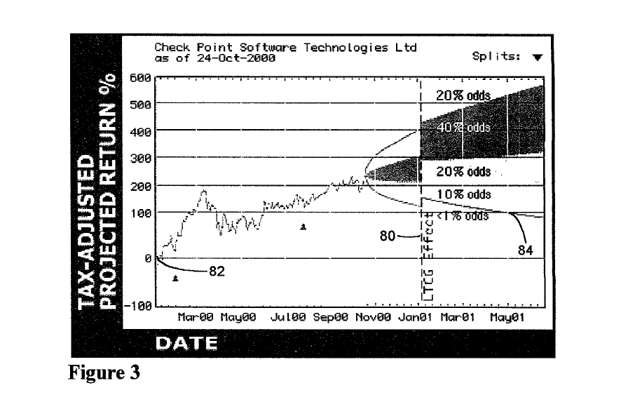

FIG. 3 is similar to FIG. 2, except that the effect of the occurrence of the long-term capital gain tax rate transition (identified as the vertical line 80 that is one year after the start date 82). After the date represented by line 80, any sale of the stock would produce a lower tax impact and a higher effective return, than under the assumption of short-term capital gain tax rate, prior to that date. For that reason, the envelope 84 is shifted upward and exploded for periods after the transition date.

Visualization of Asset Style

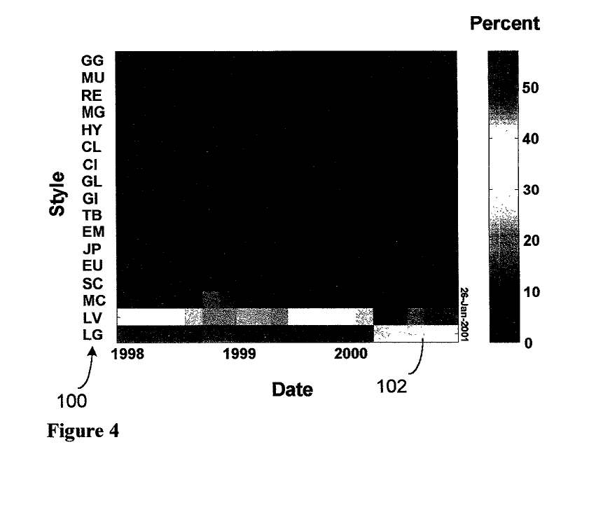

FIG. 4 shows another visualization device that reflects an asset fund style analysis that evaluates an asset fund (e.g., a mutual fund) by comparing its historical returns to those achieved by a set of basic asset classes (e.g., cash, bonds, large-cap growth stocks, large-cap value stocks).

The first step of the style analysis is a one-time selection of basic asset classes, which should be mutually exclusive and exhaustive, to represent all asset types of interest. In one example of classes (listed below) there are seventeen market indices, seven of which represent stocks and the remainder of which represent bonds.

The second step of style analysis determines the exposure of a given mutual fund to these indices. This is achieved by solving an asset class factor model, in which a fund return is expressed as a linear combination of returns from basic asset classes plus a residual. The exposures are determined by minimizing the variance of residuals using one-year weekly data. It is believed that one-year weekly data can reflect a fund style more accurately. In addition, fund exposures to basic asset classes are constrained to be non-negative and to sum to one.

The third step of style analysis is to present the results in a form that provides meaningful investment information. Style analysis results for a given fund consist of percentages in each basic asset class, with the dominant percentages determining the fund's style. Style drift for a given fund is based on determining style changes over the most recent five years.

In FIG. 4, the results of the analysis are displayed. The colors of the respective cells 102 indicate how much of the fund's performance is explained by regression to the style associated with the row in which the cell appears, during the period represented by the column in which the cell appears.

The example shown in FIG. 4 identifies each of seventeen indices (styles 100) that are of interest to a broad group of individual investors. For example, the style LG refers to a set of stocks that are characterized as Large Capitalization Growth. The full list of groups in this example follows:

1. Large-Cap Growth (LG)

2. Large-Cap Value (LV)

3. Mid-Cap (MC)

4. Small-Cap (SC)

5. European Stocks (EU)

6. Japanese Stocks (JP)

7. Emerging Markets (EM)

8. Cash (TB)

9. Intermediate Government Bonds (GI)

10. Long-term Government Bonds (GL)

11. Intermediate Corporate Bonds (CI)

12. Long-term Corporate Bonds (CL)

13. Corp Junk Bonds (HY)

14. Mortgages-Backed Securities (MG)

15. Real Estate (RE)

16. Municipal Bonds (MU)

17. Global Bonds (GG)

Thus, for cell 102, the regression indicates that about 45% of the fund's performance is correlated to the LG style for that period in 2000.

The values determined by the regression are displayed in a grid with style on the vertical axis and time on the horizontal axis. The color of each cell 102 indicates the percentage in accordance with the percentage scale shown on the right.

The resulting visualization device enables an investor to assess the performance of the asset over time relative to his investment preferences and strategy.

Visualization of Recent Market Activity

The ability to track the activity of a market of assets (such as stocks or mutual funds) as the activity unfolds is of great interest to investors. Many investors rely on daily publications of tabular data that presents information such as volume, price change, asset identification, and performance.

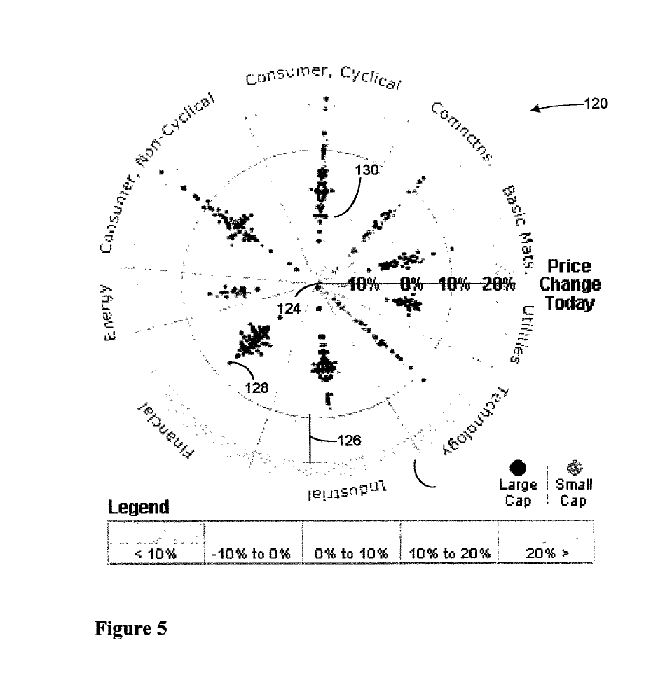

The visualization device shown in FIG. 5 collects, condenses, and enhances such information in a way that improves the ability of an investor to visually and quickly grasp recent and current market activity.

The displays are updated continually and quickly throughout a trading day.

As shown in FIG. 5, the visualization device 120 includes a radar-like display that is divided into sectors 122 arranged around a central point 124. The device is also divided into rings 126 that are centered on point 124 and filled with different colors to distinguish the different rings visually.

Each of the sectors 122 is associated with an industry or sector of interest to investors, for example the technology sector or the financial sector. The size of each sector depends on the proportion of the asset items being displayed for the sector relative to the total number of asset items being depicted for the whole universe.

Each of the rings represents a different percentage of price change during a recent period (e.g., during a single trading day). The rings are arranged with the largest percentage decline near the middle of the radar and the largest percentage increase near the periphery.

Within each of the sectors, small dots 128 are displayed each representing a selected stock or asset within the industry sector represented by the radar sector. The distance of each dot from the central point 124 represents the percentage price change of the corresponding stock at a given time during a trading day. Gray dots represent small capitalization stocks; black dots represent large capitalization stocks.

When multiple stocks in a sector have the same percentage change (e.g., at location 130), the dots are displayed at different angular positions relative to the central point, to convey to the viewer an impression of the distribution of the percentage changes within each sector.

Implementation Details

The visualization elements described above can be displayed on a wide range of devices, including desktop and laptop computers, personal digital assistants, portable telephones, publicly viewed large-screen displays, or closed circuit or broadcast/cable television monitors.

The visualization elements can be displayed alone or embedded in other displayed material, including other financial information, general news information, or program material. For example, the elements can be displayed as part of a website page dedicated to financial information or as part of a general web portal page. The elements can be displayed as part of a broadcast or cable TV program.

The raw data from which the visualization elements are created may be obtained on-the-fly electronically and/or may be stored as needed either locally or centrally. Software that processes the raw data to generate the derived values to be represented in the visualization elements may run locally or may be run remotely (and then downloaded to a local display). Software that processes the derived values to produce the visualization elements may be handled similarly.

The raw data, the derived values, and the visualization elements can be updated more or less frequently, though in many cases real-time updates are especially useful.

Each of the visualization elements could be made interactive by enabling a user to provide inputs, for example, mouse clicks, that indicate how the user wishes to alter the manner in which the elements are displayed, or the selection of data contained in them.

Configuration features can be provided to enable the user to configure what information he receives, in what form it is displayed, and how often and how currently he receives it.

Other implementations are within the scope of the following claims.

For example, with respect to the visualization element shown in FIG. 5, the overall shape of the element could be other than round, the sectors could be other than simple pie shapes, the rings could be other than simple rings, the individual dots could be replaced by other icons, the dots or other icons could be arrayed in other arrangements from the center, and visible features other than color could be used to distinguish different portions of the display.

A wide range of variants is also possible with respect to the visualization elements shown in the other figures.

1. A method comprising
displaying to a user a circular visualization element having sectors arranged around a center of the element, the sectors respectively corresponding to different groups of assets,
in each of the sectors, displaying an array of visual elements representative of respective assets belonging to the group to which the sector corresponds, the visual elements being arrayed with respect to distance from the center in accordance with magnitudes of performance of the assets during a recent period.

2. The method of claim 1 in which the visual elements comprise displayed dots, one for each of the assets.

3. The method of claim 1 in which the visual elements exhibit visible characteristics that correspond to categories of the assets within the group.

4. The method of claim 3 in which the categories of the assets within the group correspond to different capitalizations.

5. The method of claim 2 in which dots are arranged along a radius of the sector to which they belong.

6. The method of claim 5 in which dots that would otherwise lie on the radius at a given distance from the center are displayed at different angular positions near to the radius.

7. The method of claim 1 in which the sectors have angular extents that represent the fractions of the total number of asset items represented by the respective sectors.

8. The method of claim 1 in which the circular visualization element is subdivided into rings having respectively different distances from the center.

9. The method of claim 8 in which the rings are displayed in different colors.

10. The method of claim 1 in which the magnitudes of performance of the assets are measured in percentage price change.

11. The method of claim 1 in which the recent period comprises a trading day on an asset market.

12. The method of claim 1 in which the assets comprise securities issued by corporations.

13. A displayed visualization element that
is circular,
has sectors arranged around a center of the element, the sectors respectively corresponding to different groups of securities issued by corporations,
in each sector, has an array of dots representing respective securities belonging to the group to which the sector corresponds, each of the dots lying on or near a radius of the sector and each having a distance from the center along the radius that corresponds to the percentage change in the price of the represented security during a trading day, and
has differently colored rings at respectively different distances from the center.

14. A method comprising
displaying to a user a visualization element that indicates the odds of a performance measure of an asset being within specified ranges of identified values of the performance measure at a succession of times in the future.

15. The method of claim 14 in which the performance measure comprises a price of the asset.

16. The method of claim 14 in which the performance measure comprises a return percentage.

17. The method of claim 14 in which the performance measure comprises a tax-adjusted return percentage.

18. The method of claim 14 in which the visualization element include stripes superimposed on a graph of the performance measure over time, each of the stripes representing one of the specified ranges.

19. The method of claim 18 in which each of the stripes begins at a current time and becomes broader as it extends to future times.

20. The method of claim 14 also including
displaying a graphical device that shows actual historical values of the performance measure.

21. The method of claim 20 in which the graphical device that shows actual historical values is a line graph one end of which joins the visualization element at a point which represents a current date.

22. The method of claim 14 in which the visualization element includes two portions, one of the portions representing the odds prior to a specified date based on one assumption, the other of the portions representing the odds after the specified date based on another assumption.

23. The method of claim 22 in which the specified date is a date on which tax effects change from the one assumption to the other assumption.

24. A method comprising
displaying to a user a visualization element having graphical indicators of the relative performance of a selected asset compared with the performance of groups of assets in each of a succession of time periods, each of the groups comprising assets representing a common style.

25. The method of claim 24 in which the style comprises a class of investment objectives.

26. The method of claim 24 in which the relative performance is determined using an asset class factor model.
